(19) United States
(12) Patent Application Publication
(10) Pub. No.: US 2005/0050048 A1
(43) Pub. Date: Mar. 3, 2005

(54) Method and system for providing a default role for a user in a remote database

(76) Inventor: Vicki Louise Perez, Sunnyvale, CA (US)

Correspondence Address: SAWYER LAW GROUP LLP, P.O. Box 51418, Palo Alto, CA, 94303, US

(21) Appl. No.: 10/653,002

(22) Filed: Aug. 28, 2003

(51) Int. Cl. G06F 17/30

(52) U.S. Cl. 707/10

(57) ABSTRACT

A method and system for assigning a user default role in a remote database of a database system is disclosed. The method and system comprises the steps of activating a default role for the remote database and utilizing the activated default role to access data within the remote database. Accordingly, a system and method is provided that allows a user to access a remote database via a default role. The system and method only requires that default role information be stored in a current role database structure and be accessible by a user. In so doing, a user can easily access information in the remote database through the default role. Therefore, this system is compatible and easily implemented utilizing existing parallel database systems.

### FIELD OF THE INVENTION

The present invention relates generally to databases and more particularly to a method and system for providing default roles to remote databases for a user.

### BACKGROUND OF THE INVENTION

A database can be accessed by multiple users. Parallel database systems such as the Informix Extended Parallel Server, XPS, are utilized extensively for a variety of applications. There are two ways to provide permissions and privileges to a database system. The first way is to provide the permission and privileges to each user. This becomes cumbersome and complex as more users are added to the database. The second way is to provide roles with the database system and then provide a role to each user.

Roles are analogous to groups at the operating system level. They are created within a database. And they can be granted various permissions on database objects such as tables. This makes it easier to manage privileges by granting permissions to roles rather than individual users. But unlike groups at the operating system level, roles must be set using the SQL statement, such as the SQL statement, SET ROLE before a user can take advantage of the privileges assigned to the role. It is known that a default role is typically assigned to any new user of a database system. The default role typically is assigned permissions and dependent upon the requirements of the application.

However, in the XPS system, if a query accesses multiple databases, the user is only able to take advantage of the default role in the current database. The user will not be able to take advantage of any default roles assigned to the user in the remote database because the default role information is not accessible by the user.

For a more detailed description of this problem, refer now to the following discussion in conjunction with the accompanying figures. FIG. 1 is a flowchart which illustrates the accessing of data by a user in a database system. The database system includes a current database and at least one remote database. Referring to FIG. 1, it is first determined whether there is a user permission to access the current database, via step 12. If there is no user permission, then a print error 14 occurs and the user exits from the program via step 16.

If the user permission is granted, it is next determined whether there is a default role, via step 20. If there is a default role, then the default role is read for the user, via step 22. The current role is then set for the user in the database structure, via step 24. It is then determined if the user has permissions to read the table, via step 26. Returning to step 20, if there is no default role, then it is determined if the user has permissions to read the table, via step 26.

If the user does not have permissions to read the table, then it is determined if the role has permission to access the table, via step 28. If it is determined that the role does have permission to access the table, then information is retrieved from the table, via step 32.

Returning to step 26, if it is determined that the user has permissions to read the table, then information is retrieved from the table, via step 32. If the role does not have permission to access the table, that is, the role is to a remote database, then a print error occurs, via step 30.

Hence, it is not possible for the default role of a remote database to be used by a user to access information within the remote database. Therefore, as aforementioned, the user will not able to take advantage of any roles granted to a user in the remote database.

A possible alternative to this problem is to provide roles which are not specific to a database, such as global roles for all active databases. While global default roles can be active for all databases, this solution does not take advantage of roles already defined and it requires that additional roles be managed by a database administrator.

Accordingly, what is needed is a system and method which provides a default role to a user on a remote database. The method and system must be cost efficient, easily implemented and compatible with existing database systems. The present invention addresses such a need.

### SUMMARY OF THE INVENTION

A method and system for assigning a user default role in a remote database of a database system is disclosed. The method and system comprises the steps of activating a default role for the remote database and utilizing the activated default role to access data within the remote database.

Accordingly, a system and method is provided that allows a user to access a remote database via a default role. The system and method only requires that default role information be stored in a current role database structure and be accessible by a user. In so doing, a user can easily access information in the remote database through the default role. Therefore, this system is compatible and easily implemented utilizing existing parallel database systems.

### BRIEF DESCRIPTION OF THE DRAWINGS

FIG. 1 is a flowchart which illustrates the accessing of data by a user in a database system.

FIG. 2 illustrates two databases, DB1 and DB2, that are part of a parallel database system in accordance with the present invention.

FIG. 3 is a flowchart which illustrates accessing data by a user in a remote database system in accordance with the present invention.

FIG. 4 is a flowchart which illustrates activating a default role in a remote database.

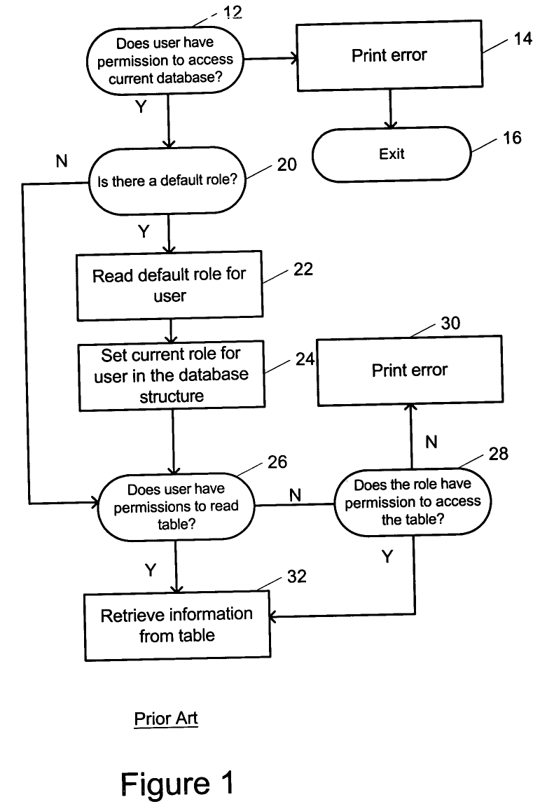

### DETAILED DESCRIPTION

The present invention relates generally to databases and more particularly to a method and system for providing default roles to remote databases for a user. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

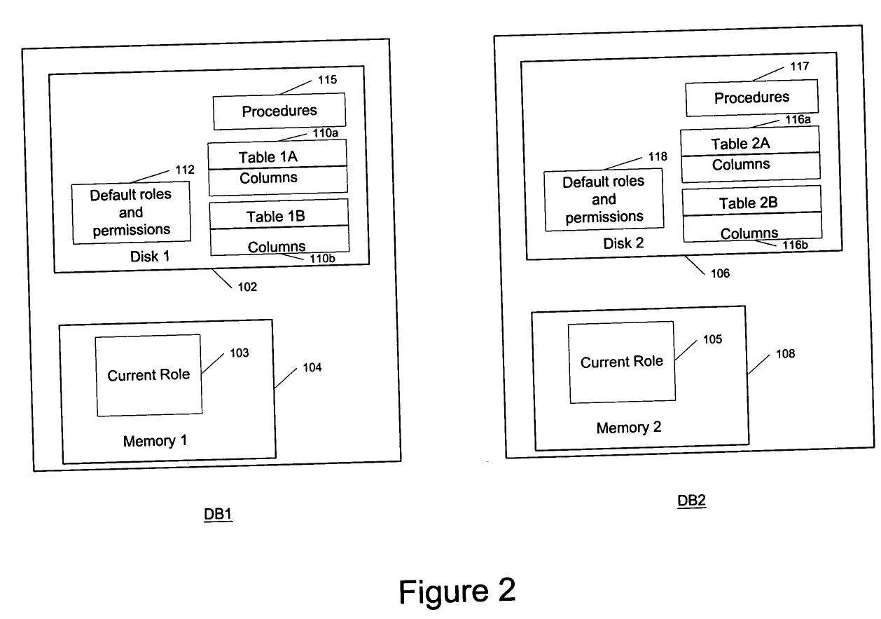

With some minor changes in logic and using database structures which are already being utilized, a system and method in accordance with the present invention can be implemented in a parallel database system such as the XPS system for allowing a user to access a remote database. FIG. 2 illustrates two databases, DB1 and DB2, that are part of a parallel database system in accordance with the present invention. DB1 comprises disk 102 and memory 104. Disk 102 includes procedures 115, default roles and permissions 112, and tables 110a and 110b. Memory 104 includes a database structure which includes the current role information 103.

DB2 comprises disk 106 and memory 108. Disk 106 comprises procedures 117, default roles and permissions 118, tables 116a and 116b. Memory 108 comprises a database instruction which includes the current role information 105. As is understood, although only two databases are illustrated, any number of databases could be used in the present invention, and that use would be within the spirit and scope of the present invention. The system and method in accordance with the present invention could be implemented by software on a computer readable medium, such as disk drive, CD, DVD or other media. In addition, the number of tables and procedures is not limited to the number shown in the figure.

In this embodiment, each of the disks 102 and 106 stores user data as well as default roles and permissions. When a user accesses a database, information about each database is stored in memory. There is a separate structure which stores this information. One of the things in this database structure is the current role information. The initial value of the current role will be whatever is defined as the current role for that user in that database.

Roles are not granted database privileges. A user must be granted privileges to a database before it can access anything. Privileges for database objects such as tables, columns, and stored procedures can be granted to roles.

Accordingly, the current role information in the remote database is utilized by the user to activate the default role for a user of the remote database. Hence, if DB1 is considered the current database and DB2 is considered the remote database, the user, upon attempting to ascertain a default role in the remote database (DB2), will determine if the current role is set in the current role information. If it has not been set, then the default information or current role information will be retrieved from the remote database and the permissions. In so doing, the default role will then be ascertained based upon the default role of the remote database assigned to the user, and the user can effectively access information within the remote database from one of the tables using the default role assigned by the remote database. For a more detailed description of the current invention, refer now to the following discussion in conjunction with the accompanying drawings.

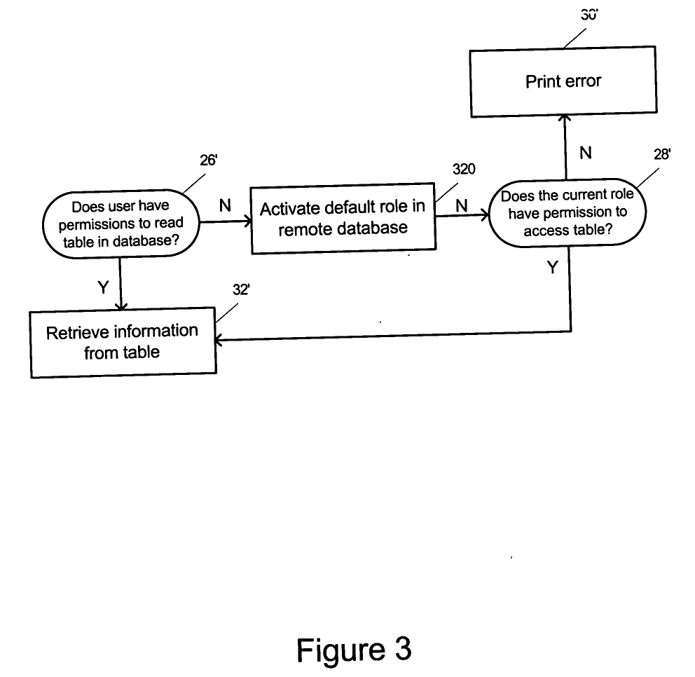

FIG. 3 is a flowchart which illustrates accessing data by a user in a remote database system in accordance with the present invention. First, it is determined if the user has permissions to read a table in a database, via step 26′. If the answer is yes, then the table is in the current database and information can be retrieved from the table, via step 32′. However, if the answer is no, then the table is in a remote database. Thereafter, a default role is activated in the remote database, via step 320. By activating the default role, tables can be accessed in the remote database. For a description of this feature, refer now to FIG. 4.

FIG. 4 is a flowchart which illustrates activating a default role in a remote database. First, the remote database is opened, via step 404. Then it is determined if the current role has been set in current role information, via step 408. If the current role has been set, then the role permissions are checked, via step 28′ (from FIG. 3).

If the current role has not been set, then it is determined if there is a default role for the user in the current role information, via step 410. If there is not a default role for the user, then role permissions are checked, via step 28′. If there is a default role for the user, then the current role is set to be the default role, via step 414, following which role permissions are checked, via step 28′.

Referring back to FIG. 3, after the default role is activated, via step 320, it is then determined if the current role has permission to access the table, via step 28′. If the current role does not have permission to access the table, then a print error occurs, via step 30′. If the current role does have permission to access the table, then information is retrieved from the table, via step 32′.

Accordingly, a system and method is provided that allows a user to access a remote database via a default role. The system and method only requires that default role information be stored in a current role database structure and be accessible by a user. In so doing, a user can easily access information in the remote database through the default role. Therefore, this system is compatible and easily implemented utilizing existing parallel database systems.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

1. A method for assigning a user a default role in a remote database of a database system, the method comprising the steps of:
(a) activating a default role for the remote database, and
(b) utilizing the activated default to access data within the remote database.

2. The method of claim 1 wherein the activating step (a) comprises the steps of
(a1) retrieving current role information of the remote database; and
(a2) utilizing the current role information to allow the user to access data in the remote database based upon the default role of the remote database.

3. The method of claim 1 wherein the remote database contains tables.

4. The method of claim 1 wherein the database system comprises a parallel database system.

5. A computer readable medium containing program instructions for assigning a user a default role in a remote database of a database system, the program instructions:
(a) activating a default role for the remote database, and
(b) utilizing the activated default to access data within the remote database.

6. The computer readable medium of claim 5 wherein the activating step (a) comprises the steps of
(a1) retrieving current role information of the remote database; and
(a2) utilizing the current role information to allow the user to access data in the remote database based upon the default role of the remote database.

7. The computer readable medium of claim 5 wherein the remote database contains tables.

8. The computer readable medium of claim 5 wherein the database system comprises a parallel database system.

9. A system for assigning a user a default role in a remote database of a database system, the system comprising:
means for activating a default role for the remote database, and
means for utilizing the activated default to access data within the remote database.

10. The system of claim 9 wherein the activating means comprises:
means for retrieving a current role information of the remote database; and
means for utilizing the current role information to to allow the user to access data in the remote database based upon the default role.

11. The system of claim 10 wherein the default role from the remote database is stored in the current database.

12. The system of claim 9 wherein the remote database contains tables.

13. The system of claim 9 wherein the database system comprises a parallel database system.
